(19) United States
(12) Patent Application Publication
(10) Pub. No.: US 2005/0223125 A1
(43) Pub. Date: Oct. 6, 2005

(54) Multi-interfacing in a reconfigurable system

(75) Inventor: William C. DeLeeuw, Portland, OR (US)

Correspondence Address: VENABLE LLP, P.O. BOX 34385, WASHINGTON, DC, 20045-9998, US

(73) Assignee: Intel Corporation, Santa Clara, CA (US)

(21) Appl. No.: 10/813,063

(22) Filed: Mar. 31, 2004

(51) Int. Cl. G06F 13/12

(52) U.S. Cl. 710/11; 710/62

(57) ABSTRACT

In a reconfigurable communication network, a device may be equipped to support connecting to a single host using more than one communication protocol and more than one communication interface with the host.

### BACKGROUND OF THE INVENTION

The number of different communication protocols, for hardwired and/or wireless communications, has burgeoned. Additionally, reconfigurable communication systems have been proposed, in which a single device may be capable of using one or more protocols for communicating. When multiple protocols are used, this may present a problem for a single device, for example, a host computer, trying to communicate. For example, there may be a single interconnect to a host bus of the host computer, and if so, concurrent protocol instances must share access through the single interconnect. The result of this may be contention between competing protocols and possible blocking of communications, thus degrading system performance.

### BRIEF DESCRIPTION OF THE DRAWINGS

Embodiments of the invention will now be described in conjunction with the accompanying drawings, in which:

FIG. 1 depicts a host device having a single driver to communicate using a single protocol with a communication device using a single protocol, as may occur in some embodiments of the invention;

FIG. 2 depicts a host device having a single driver that may communicate using multiple protocols, as with a reconfigurable communication device, as may occur in some embodiments of the invention;

FIG. 3 depicts a host device having multiple drivers that may communicate using multiple protocols, as with a reconfigurable communication device, as may occur in some embodiments of the invention;

FIG. 4 depicts a variation on the arrangement of FIG. 3, as may occur in some embodiments of the invention; and

FIG. 5 depicts a conceptual block diagram of a system according to an embodiment of the invention.

### DETAILED DESCRIPTION OF VARIOUS EMBODIMENTS OF THE INVENTION

In the following description, numerous specific details are set forth. However, it is understood that embodiments of the invention may be practiced without these specific details. In other instances, well-known circuits, structures, and/or techniques have not been shown in detail in order not to obscure an understanding of this description.

References to “one embodiment”, “an embodiment”, “example embodiment”, “various embodiments”, etc., indicate that the embodiment(s) of the invention so described may include a particular feature, structure, or characteristic, but not every embodiment necessarily includes the particular feature, structure, or characteristic. Further, repeated use of the phrase “in one embodiment” does not necessarily refer to the same embodiment, although it may.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments of the present invention may include apparatuses for performing the operations herein. An apparatus may be specially constructed for the desired purposes, or it may comprise a general purpose device selectively activated or reconfigured by a program stored in the device.

Embodiments of the invention may be implemented in one or a combination of hardware, firmware, and software. Embodiments of the invention may also be implemented as instructions stored on a machine-accessible medium, which may be read and executed by a computing platform to perform the operations described herein. A machine-accessible medium may include any mechanism for storing or transmitting information in a form readable by a machine (e.g., a computer). For example, a machine-accessible medium may include read only memory (ROM); random access memory (RAM); magnetic disk storage media; optical storage media; flash memory devices; electrical, optical, acoustical or other form of propagated signals (e.g., carrier waves, infrared signals, digital signals, etc.), and others.

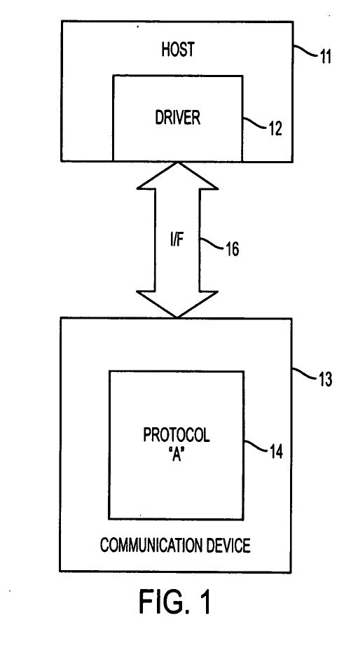

FIG. 1 depicts a situation that may occur in some reconfigurable communication systems. In FIG. 1, a host device (e.g., a host computer) 11 may be furnished with a single driver 12 and a single interface (I/F) 16 (taken together, driver 12 and I/F 16 may be considered to be a “communications module” or “communications subsystem”). Driver 12 may be implemented in hardware, software, firmware, etc., or combinations thereof, and it may be implemented separately from or integrated with the host device 11 (this includes the possibility that it may be implemented at least partially in software capable of being executed on the host device 11). The single I/F 16 may also be implemented in one of or in combinations of hardware, software, firmware, etc., and may be capable of facilitating connectivity between driver 12 and a device 13. As a result, driver 12 may be capable of communicating with devices in a communication network using a single protocol, which, for the purposes of this discussion, will be denoted “Protocol ‘A’.” Therefore, a single-protocol device 13 may be equipped with Protocol “A” 14 and may thereby communicate with host device 11, via driver 12 (note that the protocol 14 may be implemented in hardware, software, firmware, etc., or in combinations thereof) and I/F 16. Such a situation may arise in conventional communication networks, as well.

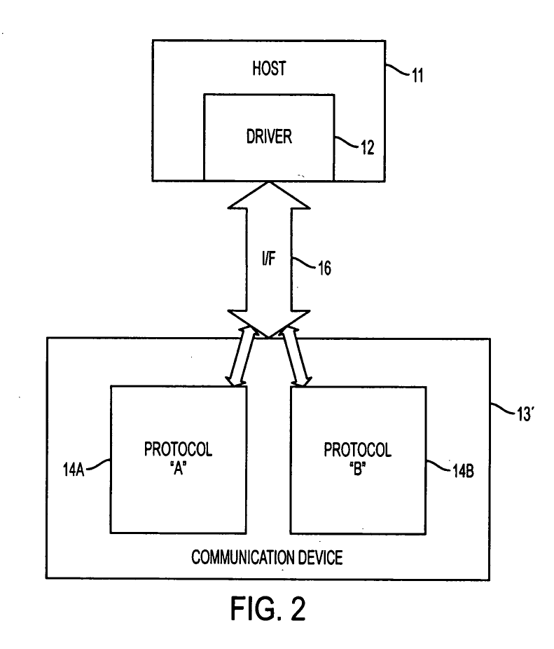

FIG. 2 depicts a somewhat different scenario from that shown in FIG. 1. In FIG. 2, a communication device 13′ may be capable of communicating using multiple protocols, 14A and 14B, here denoted “Protocol ‘A’” and “Protocol ‘B’,” respectively. Note that a multi-protocol communication device 13′ may be equipped with two or more communication protocols, and is not limited to the case of two protocols as shown in FIG. 2. Communication device 13′ may be software reconfigurable to use one or more protocols for communication, and it may represent or include a reconfigurable communication system (RCS) that may be coupled to host 11. As in FIG. 1, host 11 may be furnished with a single driver 12 and with a single I/F 16. Therefore, if both protocols 14A and 14B are being used, the communications using the different protocols may need to share, using any appropriate multi-access method (e.g., but not limited to, time sharing and contention), access to host 11 via the same driver 12 and/or I/F 16. As a result, both may not be able to communicate, and this may cause, for example, communication delays and/or loss of information. For example, data flow congestion in one protocol may adversely affect communications using the other protocol. Such effects may be a result, for example, of the protocols needing to share one or more common resources.

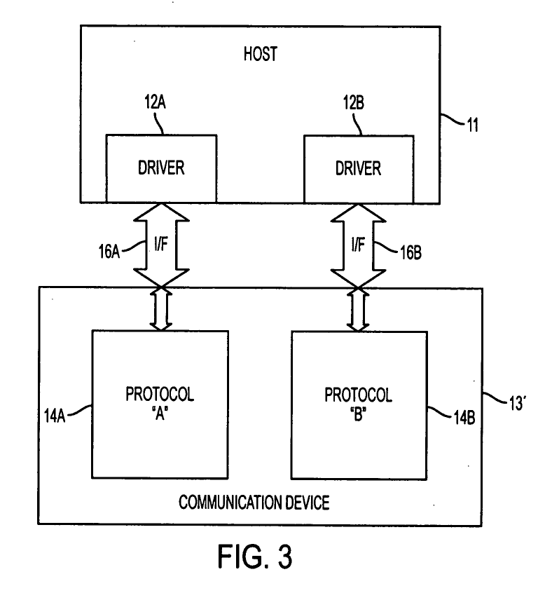

FIG. 3 depicts a host device 11 that may be equipped to communicate using more than one protocol. In FIG. 3, host device 11 may be provided with two drivers, 12A and 12B; however, in various embodiments, more than two drivers may be provided. Additionally, two I/Fs, 16A and 16B may also be provided (again, more than two may be provided), and I/Fs 16A and 16B may be of the same type or of different types. The number of drivers and/or I/Fs may depend upon the number of protocols via which it may be desired to communicate, and therefore, this may provide a degree of scalability and flexibility to the system. In FIG. 3, multi-protocol device 13′ is shown, as in FIG. 2, having two protocols 14A and 14B, either or both of which may be used for communicating at any given time. If both protocols 14A and 14B are used, and if drivers 12A and 12B are designed to be compatible with the respective different protocols, then communications may occur between multi-protocol device 13′ and host device 111 via both protocols, without sharing between the protocols of use of a single driver 12 and/or interface 16, as in FIG. 2. Note that it may be possible that both protocols 14A and 14B may be the same protocol and/or that drivers 12A and 12B may be different instantiations of the same driver.

In FIG. 3, each of drivers 12A and 12B may be capable of communicating using multiple protocols at various times. This may be accomplished, for example, by means of hardware, software, firmware, etc., or combinations thereof. For example, a protocol may be changed by executing software implementing a different protocol, or by switching in and out different firmware; however, the invention is not limited to these examples.

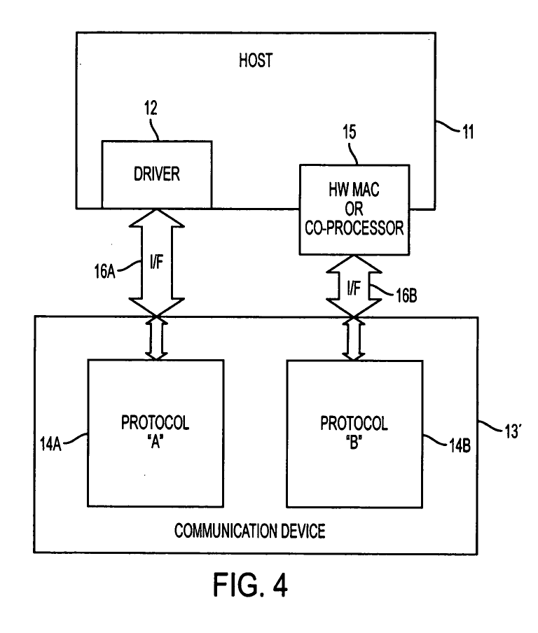

FIG. 4 depicts a variation on the embodiment shown in FIG. 3. A given host interface need not connect directly to the host 11. On the contrary, it may be implemented through another device, such as a hardware medium-access controller (HW MAC) or surrogate processor coupled to host 11. The host device 11 in FIG. 4 may be equipped with such a HW MAC or co-processor 15. In this case, the HW MAC or co-processor 15 may act as a proxy for host 11.

The use of such a HW MAC or co-processor 15 may provide a means by which to conserve power. In particular, if HW MAC or co-processor 15 handles communications via some communication protocol, and if the host 11 is capable of entering a low-power sleep mode, host 11 may remain in a sleep mode or may be awakened by HW MAC or co-processor 15. Whether or not host 11 is awakened may, for example, depend on the occurrence of some predetermined event, such as, but not limited to, whether or not a particular communication task may be handled by the HW MAC or co-processor 15, acting alone, or if the host 11 is needed to handle the task. Other criteria may be used, as would be known by a system designer of ordinary skill in the art.

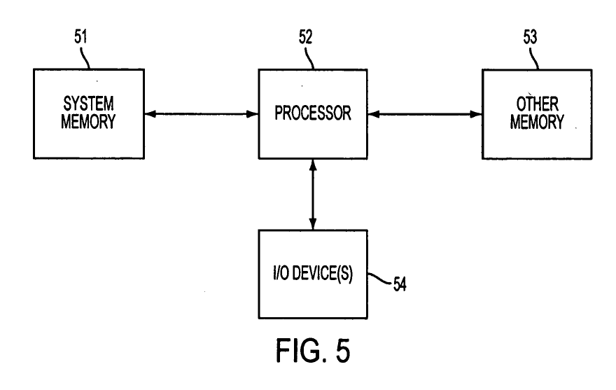

Some embodiments of the invention, as discussed above, may be embodied in the form of software instructions on a machine-accessible medium. Such an embodiment is illustrated in FIG. 5. The computer system of FIG. 5 may include at least one processor 52, with associated system memory 51, which may store, for example, operating system software and the like. The system may further include additional memory 53, which may, for example, include software instructions to perform various applications. System memory 51 and additional memory 53 may comprise separate memory devices, a single shared memory device, or a combination of separate and shared memory devices. The system may also include one or more input/output (I/O) devices 54, for example (but not limited to), keyboard, mouse, trackball, printer, display, network connection, etc. The present invention may be embodied as software instructions that may be stored in system memory 51 or in additional memory 53. Such software instructions may also be stored in removable or remote media (for example, but not limited to, compact disks, floppy disks, etc.), which may be read through an I/O device 54 (for example, but not limited to, a floppy disk drive). Furthermore, the software instructions may also be transmitted to the computer system via an I/O device 54, for example, a network connection; in such a case, a signal containing the software instructions may be considered to be a machine-accessible medium.

The invention has been described in detail with respect to various embodiments, and it will now be apparent from the foregoing to those skilled in the art that changes and modifications may be made without departing from the invention in its broader aspects. The invention, therefore, as defined in the appended claims, is intended to cover all such changes and modifications as fall within the true spirit of the invention.

1. An apparatus, comprising:
a communication device supporting communication using at least two communication protocols, wherein said communication device is adapted to be coupled to at least two communication interfaces.

2. The apparatus according to claim 1, wherein said at least two communication interfaces are coupled to a single computing platform.

3. The apparatus according to claim 1, wherein said communication device comprises software to configure the communication device to communicate using each of said at least two communication protocols.

4. The apparatus according to claim 1, wherein said communication device comprises a reconfigurable communication system.

5. A system comprising:
a communication device supporting communications using at least two communication protocols;
a computing platform; and
at least two communication subsystems coupled to said computing platform, each of said communication subsystems adapted to communicate with said communication device using at least one of said at least two communication protocols.

6. The system according to claim 5, wherein at least a portion of at least one of said communication subsystems is implemented as a device coupled to said computing platform.

7. The system according to claim 6, wherein said device comprises:
at least one of a hardware medium-access device and a co-processor.

8. The system according to claim 7, wherein said computing platform is adapted to execute a low-power sleep mode, and wherein said at least one of a hardware medium-access device and a co-processor is adapted to awaken said computing platform from said low-power sleep mode upon occurrence of a predetermined event.

9. The system according to claim 5, wherein at least one of said communications subsystems is adapted to communicate using more than one communication protocol.

10. The system according to claim 9, wherein at least a portion of at least one of said communication subsystems is adapted to be changeable between at least two communication protocols.

11. The system according to claim 5, wherein at least one of said communication subsystems comprises:
a driver; and
a communications interface coupled to said driver.

12. The system according to claim 5, wherein said communication device comprises a reconfigurable communication system.

13. The system according to claim 5, wherein said communication device is software reconfigurable.

14. A method, comprising:
coupling a communication device to a computing platform, said coupling comprising:
coupling to said computing platform using a first communication protocol; and
coupling to said computing platform using a second communication protocol.

15. The method according to claim 14, wherein said coupling to said computing platform using a first communication protocol and coupling to said computing platform using a second communication protocol comprise:
sharing a single communication interface coupled to said computing platform.

16. The method according to claim 14, wherein said coupling to said computing platform using a first communication protocol comprises coupling to a first communication interface using said first communication protocol; and
wherein said coupling to said computing platform using a second communication protocol comprises coupling to a second communication interface using said second communication protocol.

17. The method according to claim 14, wherein said coupling a communication device further comprises:
reconfiguring said communication device to communicate utilizing a third communication protocol, wherein said third communication protocol is used instead of one of said first communication protocol and said second communication protocol.

18. A machine-accessible medium containing instructions that, when executed by a processor, cause said processor to execute a method comprising:
configuring said processor to couple, using at least two communication protocols, to at least two communication interfaces coupled to a computing platform.

19. The machine-accessible medium according to claim 18, containing further instructions that, when executed by said processor, cause the method executed by said processor to further comprise:
reconfiguring at least one of said at least two communication protocols to a different communication protocol.

20. The machine-accessible medium according to claim 18, wherein said at least two communication protocols comprise at least two different communication protocols.
